(19) United States
(12) Patent Application Publication
(10) Pub. No.: US 2002/0056380 A1
(43) Pub. Date: May 16, 2002

(54) Media for gel-ink printing

(76) Inventors: Tom Wien, Newport Beach, CA (US); Jacques Arthur Plummer, Ontario, CA (US); Anahit Tataryan, Temple City, CA (US); Kara Angela Roman, Los Angeles, CA (US)

Correspondence Address: OPPENHEIMER WOLFF & DONNELLY LLP, 2029 Century Park East, 38th Floor, Los Angeles, CA, 90067-3024, US

(21) Appl. No.: 09/881,328

(22) Filed: Jun. 14, 2001

Related U.S. Application Data
(60) Provisional application No. 60/249,544, filed on Nov. 15, 2000.

(51) Int. Cl. B05C 17/06

(52) U.S. Cl. 101/128.21

(57) ABSTRACT

Substrates having gel ink receptive surfaces as well as an economical and versatile method for their production is provided. The substrates are comprised of media having a dark gel ink writeable surface that is comprised of dark ink disposed upon lighter substrates, as provided by the methods detailed herein. The teachings of the present invention provide users with methodologies that render various substrates, such as paper, particularly amenable to the deposition and display of indicia comprised of gel ink.

### RELATED APPLICATIONS

The present application claims priority from U.S. Provisional Patent Application, serial number 60/249,544, which was filed on Nov. 15, 2000.

### BACKGROUND OF THE INVENTION

1. Field of the Invention

The present invention relates to media having a dark and/or colored background onto which gel ink may be written and, in particular, a media onto which a dark and/or colored background has been applied as an ink.

2. General Background and State of the Art

Gel ink pens utilize a color ink composition that typically has a metallic luster. The ink may be applied to either light or dark substrates, as compared to traditional inks that are visible only when applied to light substrates. One example of a gel ink composition includes very fine metal powder, which is typically a copper alloy, aluminum, copper and/or zinc powder that is treated with a fatty acid or salt; a petroleum resin; solvents; and a pigment and pigment dispersing agent, among other components.

Gel ink pens are commercially available from a number of vendors, including BIC USA Inc., headquartered in Milford, Conn and Sakura of America of Hayward, Calif.

It is often desirable to write alphanumeric characters and/or graphics with gel ink onto a dark substrate, such as dark construction paper. The effect can be dramatic, with a colorful metallic ink shimmering off of the dark substrate. However, dark paper is often relatively expensive as compared to white paper, for example.

### INVENTION SUMMARY

Accordingly, one of the objects of the present invention is to provide methods for producing, or manufacturing, media for gel ink printing. Printing, as utilized herein, is meant to encompass various methods utilizable in the application of various compositions, such as gel inks for example, onto media or substrates. Therefore, handheld writing instruments, such as pens, and various printers, such as ink jet printers, are exemplary components of methods that comprise printing. Media may be made up of a multi-layered construction or single layer of material, comprised of a substrate or surface upon which dark and /or colored ink has been applied, providing gel ink writeable/printable material, in accordance with the teachings of the present invention. A broad aspect of the invention involves printing a black or dark colored ink onto an area of white or light colored substrate such as paper, and writing with a contrasting gel ink onto the dark areas.

It is an additional object of the present invention to provide compact stackable media for gel ink printing. That is, collections comprised of a plurality of gel ink substrates/media may be stacked one upon the other to form a convenient construction similar to the glue bound pages of a book, so that a user may, if desired, separate a sheet or sheets of the gel ink media/substrate from the stack. Such exemplary constructions include, for example, note pads and notebooks. In the pad example, stacked sheets comprised of the gel ink media/substrate are stacked one on top of the other and bound into a pad by glues and/or adhesives at a one end, for example. Additional exemplary methods of binding a plurality or stack of sheets comprised of gel ink media/substrates, may include wiring, clasps and other methods to bind stacks of sheets, separable from the stack or each other, as known to those skilled in the art.

It should be noted that single sheets of media for gel ink printing, having dark and/or colored surfaces, are provided by the teachings of the present invention.

The present invention relates to making gel ink-writeable substrates by printing a dark and/or colored ink onto a light-colored substrate to form a dark and/or colored substrate. In one embodiment of the invention, the substrate is a label sheet, in which the labels are printed with a dark and/or colored ink. A user may, for example, write and/or print onto the darkened and/or colored substrate with a gel ink pen or utilize a desktop printer containing cartridges which contain gel ink, respectively, or other printing processes as known in the art, to create a desirable visual effect.

In accordance with the methods of manufacturing taught herein, the present invention provides gel ink-writeable substrates with high optical density values. The present invention further provides gel ink writeable substrates that have positive writing attributes such as superior ink laydown and the accentuation of gel inks, especially gel inks having metallic components and/or pastel coloration.

In accordance with a specific illustrative embodiment of the invention, a gel ink writable pad assembly includes a plurality of label assemblies in a stack, with each label assembly including a backing or liner sheet coated with a thin release layer such as silicone and a facestock layer, die cut to form a label, and a layer of adhesive on the facestock between the facestock and the liner or backing sheet. The facestock is of a white or light colored paper. The label has one or more layers of black ink or other dark ink thereon, with the outer part of the facestock being of a lighter color or pattern, for example. Gel ink of a contrasting color may be employed to write on the dark label areas of the facestock.

The pads of label assemblies may be fairly small, for example, 3 inches by six inches or less, or two inches by four inches or less, for examples. The facestock outside the labels may include the instructions “Labels for Gel Pens”.

Other objects, features and advantages of the invention will become apparent from the following detailed description, taken in conjunction with the accompanying drawings which illustrate, by way of example, the principles of the present invention.

### BRIEF DESCRIPTION OF THE DRAWINGS

FIG. 1 is a front view of an exemplary single-label sheet wherein the label has been die cut from the face stock and has been printed with a dark ink to form a gel ink writable surface on a label, and further depicting indicia thereon disposed comprised of gel ink;

FIG. 2 is a front view of an exemplary label having a gel ink writable surface, shown being removed from a single label sheet;

FIG. 3 is a partial cross-sectional view taken along line 3-3 of FIG. 1, of an exemplary adhesive label sheet illustrating the principles of the present invention;

FIG. 4 is a diagram of an exemplary method of providing gel-ink writable substrates in accordance with the teachings of the invention;

FIG. 5 is a front view of an exemplary writing kit comprising a gel ink writing instrument and label pad, comprised of plurality of exemplary gel ink-writeable labels which have been die cut from the face stock and printed with a dark ink to form a gel ink writable surface; and

FIG. 6 is a front view of a label formed in accordance with the teachings of the present invention, wherein a gel ink pen is shown being utilized in laying down gel ink onto an exemplary gel ink writeable surface.

### DETAILED DESCRIPTION OF THE PREFERRED EMBODIMENTS

The present invention relates to making gel ink-writeable materials, such as labels, by printing a dark and/or colored ink onto a light-colored substrate. This results in a cost savings, as the cost of printing ink onto a light-colored substrate, such as white paper facestock, is usually less than using an inherently dark-colored material such as colored paper. Buying colored paper is costly, requires long lead time and minimum quantities of purchase. On special applications or testing a new concept, high cost can prohibit one from pursuing the idea.

Further, by disposing dark colored inks onto light colored substrates, and thus providing a dark substrate, the process not only provides beneficial cost reduction, but also provides a valid enhancement to the range of uses to which, on hand, white paper facestock or any variety of light colored paper, may be applicable. It is to be noted that the instant invention is not limited to the utilization of white paper facestock. By means of example and not of limitation, additional exemplary gel-ink writeable/printable substrates may be comprised of vinyls, various plastics, various foams, fabrics as well as various paper including off white or light gray paper.

Basically, starting with a white paper base, dark colors such as but not limited to black, purple, dark blue, dark maroon or burgundy and a wide variety of other colors can be printed onto an existing white paper or a white tape construction to form a gel ink-writeable/printable substrate. In accordance with the teachings of the present invention, an exemplary description of a method for the formation and manufacturing of improved gel ink media receptive to gel ink printing/writing, is herein provided. Exemplary gel ink substrates thus produced display characteristics that render these media/substrates advantageously receptive to gel inks of various colors and compositions, thus improving the appearance of indicia, comprised of gel ink, when disposed upon the dark and/or colored substrate provided by the present invention. Furthermore, substrates for gel ink printing produced in accordance with the teachings of the present invention exhibit a reduction of common undesirable artifacts associated with gel ink writing and/or printing. Exemplary artifacts include, for example, ink pooling and the often commensurate “dulling effect” of the reduction of contrast between gel inks and light colored substrates, as frequently observed when gel inks are laid down upon prior art light colored substrates, as well as other artifacts.

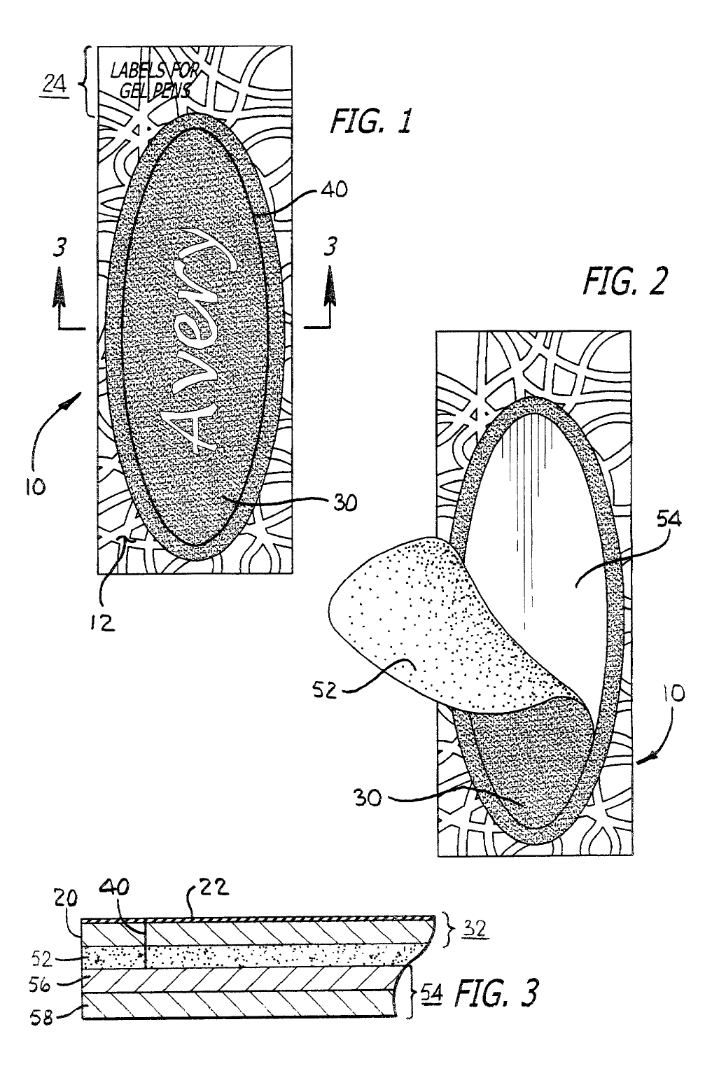

Referring to the drawings, particularly FIGS. 1 and 2, examples of labels for gel-ink printing, formed in accordance with the present invention, are depicted. An exemplary multi-layered construction, here a label sheet 10, is comprised of a standard silicone-coated backing sheet or liner 54 (see, e.g. reference numeral 54 in FIG. 2, which shows liner 54, where label 30 is shown partially removed) and white paper facestock layer 20 that is printed with ink, as described below and depicted in FIG. 3, providing media for gel ink printing.

FIG. 3 is a partial cross section of an exemplary label sheet 10 of FIG. 1, manufactured in accordance with the teachings of the present invention. Top-most ink layer 22 is comprised of black or dark colored ink, as previously described. Ink layer 22 is disposed upon facestock layer 20 to render a gel ink writeable surface 32. As an example, liner 54 is comprised of 45 lb. liner paper 58 which is uncoated on one side, and designed to optimize layflat performance over a broad range of relative humidities. Layflat performance relates to the tendency of a sheet to remain flat and not curl under wet conditions. Liner 54 may be treated on one side with silicone 56, for example, so that the adhesive 52 component of label 30 does not bind the facestock 20 and liner 54 together permanently. As previously mentioned, exemplary liner paper 58 may be comprised of 45 lb. paper, but other paper weights are also usable.

The middle layer depicted in FIG. 3 is comprised of adhesive 52. Various types of adhesive 52 may be utilized in accordance with the teachings of the present invention, such as, but not limited to, pressure sensitive, permanent and removable adhesives, for examples.

Still referring to FIG. 3, a variety of paper weights are utilizable for facestock layer 20 in light of the teachings of the present invention. For example, labels formed in accordance with one exemplary aspect of the present invention, may be comprised of a white paper face stock of 50 lb. paper. Furthermore, additional paper weights that may be employed include paper having weights from about 40 lbs. to 100 lbs., for example. There is typically less of a tendency for paper of heavier weights, to curl subsequent to the deposition of inks, than lighter weights of paper. Additional details regarding desirable curl characteristics of the exemplary label sheets are provided in the description of the exemplary method for the manufacturing of gel ink media having gel ink-writeable surfaces 32.

Considering particular aspects and returning to FIG. 1, label sheet 10 is depicted wherein a portion of the facestock layer 20 is printed with background text and/or graphics 24, and may include instructions or a legend such as “Labels for Gel Pens”. Exemplary background text and/or graphics, such as those examples depicted in the figures, are typically referred to as “matrix-printing”, and may be printed onto the entire surface of facestock 20. As such, FIG. 1 is exemplary only and is not intended to limit the present invention to specific relative dimensions, appearance and/or graphic designs.

Still referring to FIG. 1, removable label 30 is formed by a die cut into the face stock, to form a label that is defined on its edges by a die cut 40. Label 30 is printed with a black or other dark-colored ink to form a gel ink-receptive surface. Note that the dark ink has been printed beyond die cut 40 that outlines label 30, in order to ensure that label 30, is completely printed with ink. Exemplary methods of producing media for gel ink printing, in accordance with the teachings of the present invention, are presented below. The exemplary process detailed herein is directed to an embodiment of the present invention, namely, the production of stackable adhesive label sheets 10 having gel ink receptive writeable/printable surfaces 32. The user may write onto the dark gel ink-receptive surface with a gel ink pen.

The production of stackable, gel ink labels having gel ink receptive substrate areas is a multi-step process. It is to be noted that the number and location of various steps and stations in the following manufacturing description are exemplary and are not intended to limit the present invention to the precise configurations and manufacturing steps presented.

The first step in the production of exemplary labels, having gel ink-writeable surfaces 32, comprises providing a label stock construction 66 that will undergo the various steps of the manufacturing process. An exemplary label stock construction 66 may be comprised of a light colored substrate such as paper facestock 20, adhesive 52 and liner 54 (comprised of liner paper 58 and a releasable coating 56) having a cross section similar to FIG. 3 but lacking ink layer 22, and with the die cut 40 not yet being effected.

In this example, paper facestock 20 is Fasson® 50# Laser-shade 9010. This exemplary facestock is a white, uncoated sheet having an optical brightener, smooth finish and improved toner anchoring properties. It should be noted that in this example paper facestock 20 is uncoated, however topcoatings having particular formulations may be applied onto the surface of and/or integrated with paper facestock 20 in order to enhance print performance of various instruments, such as writing instruments.

Exemplary adhesive 52 is Fasson R S490 general purpose emulsion acrylic type adhesive which possesses good adhesion to many substrates, excellent die cutting and stripping characteristics, especially on wide-web applications, as those skilled in the art will appreciate. While this is a permanent type of adhesive, other releasable/removable and pressure sensitive adhesives may also be utilized.

Exemplary liner 54 is comprised of Fasson 45 lb uncoated liner paper 58, designed to optimize layflat performance, that is, the ability of sheets, such as paper, to resist curling, as known to those skilled in the printing arts. The total caliper, or thickness, of label stock construction 66, can be about 0.007 inches, but may range from about 0.005. to about 0.012 inch. Preferably the thickness will not be greater than about 0.015, for easy processing through printing equipment. Label stock construction 66 is typically provided as a blank roll measuring about 15.5 inches in width, although other widths are utilizable depending upon the desired final product specifications and available processing equipment.

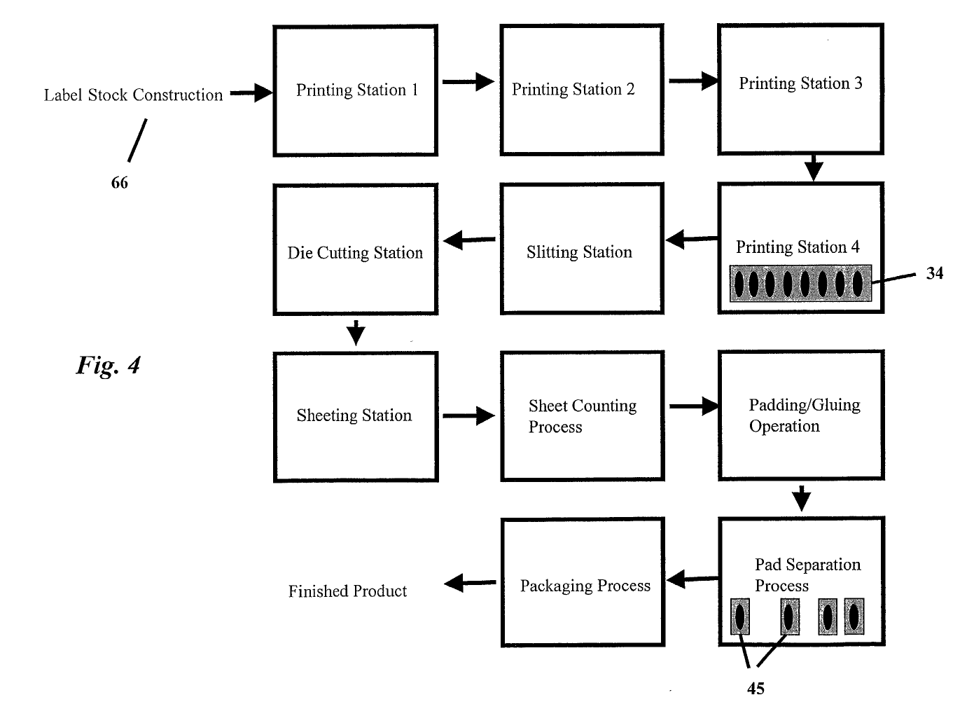

A multi-step manufacturing method is diagramed in FIG. 4. The exemplary method provided converts blank rolls of label stock construction 66, as described above, into stackable and bindable label sheets with dark ink thereon disposed, in order to provide an exemplary pad comprising a plurality of label sheets 10 with a dark gel ink-writable surface 32, in accordance to the teachings of the present invention.

Turning to FIG. 4, the method of providing an exemplary pad comprising a plurality of label sheets with a dark gel ink-writable surface 32 is outlined as a flow chart. To start, media such as rolls of label stock construction 66, as detailed above, are fed into a printing line of equipment, so that label stock construction 66 may be positioned and passed along to the various stations, where label stock construction 66 is subjected to various processing steps, that ultimately provides a pad of gel ink label sheets. Label stock construction 66 may be blank, light colored or possess pre-printed elements, such as border art and the like.

Referring to FIGS. 1, 3, and 4 of the exemplary process, the background border portion 12 and gel ink-writable surface 32 portion of future label sheets 10 are flexographically printed upon paper facestock 20 utilizing flexographic inks known in the art, which eliminates the need of pre-colored face paper (recall that exemplary facestock 20 is white). Although flexography is the printing process utilized throughout this example other printing processes may be also employed without departing from the scope of the present invention, such as UV and offset printing, for example. In some embodiments a dark gel ink-writable surface 32 may be printed onto the substrate (here label stock construction 66 comprised of facestock 20) by an ink jet printer or laser printer.

In one embodiment of the present invention, as seen in FIG. 1, facestock 20 is imprinted with background border portion 12 which may extend throughout the facestock 20 portion, excluding the label 30 portion. As previously mentioned, background border portion 12 may be “matrix printed”, that is, have a variety of ornamental designs. As depicted throughout the drawings, background border portion 12 may be comprised of a “squiggly-type” pattern. Any other type of pattern, figures, shapes or geometry may be printed and comprise background border portion 12 as an ornamental pattern. Printing of background border portion 12 of future label sheet 10 is carried out at stations 1 and 2, where printing takes place onto the width of label stock construction 66. In this exemplary process, a light colored background is first printed over the entirety of facestock 20 at print station 1. At print station 2, a second darker ink may be disposed upon facestock 20, which has the first light colored ink previously mentioned, to give a border pattern, as depicted in FIG. 1, for example. In the example herein provided, the second, patterned, ink is excluded from the area that is to be eventual label portion 30 of label sheet 10, unlike the first light ink which is printed onto the entirety of facestock 20. Additional or fewer stations may be utilized depending upon the type of pattern and colors desired for background border portion 12.

At print station 3, a dark colored ink is printed upon each of the developing label sheets 10 in the desired shape of label 30. Exemplary label 30, as depicted in FIGS. 1 and 2, is in the shape of an oval. It is considered within the scope of the present invention to lay down darkly colored ink to form labels having gel ink-writable surfaces 32 in practically any geometry as desired by a manufacturer or customer, as seen in FIG. 5, for example.

Moving to print station 4, a second dark colored label shape is printed over the previously dark colored label shape printed onto label sheet construction 66 at print station 3. This “double hit” imparts a dense, dark appearance to the label portion 30 of the label sheet 66 that will comprise the gel ink-writable surface 32 . It is to be noted that exemplary label 30 is comprised three rounds of printing of ink thereon disposed. That is, a “double hit” of the dark ink, for example black ink, is printed upon the first light ink which is printed onto the entirety of facestock 20. An exemplary average optical density value of gel ink-writable surface 32 is about 1.33. It may be noted that a considerable amount of dark ink is disposed onto label 30 area and that the label stock construction 66 should have good layflat characteristics, as detailed earlier.

One aspect of the printing process involves the print registration of the background colors and shapes. This may be accomplished by the utilization of laser engraved cylinders, which provide accurate print registration on the press at high speeds (about 300+ feet per minute or higher).

After passing through printing station 4, label stock construction 66, now having a plurality of adjacent label sheets 10, each with printed background border portion 12 and label portion 30 in a configuration exemplified by FIG. 1, passes to the slitting station where about 0.25 inches of label stock construction 66 is slit and removed from each side of the sheet of label stock construction 66. Recall, that the exemplary width of the roll of label stock construction 66 is about 15.5 inches. In the exemplary case herein described, this results in label stock construction sheet 34 being about 15 inches across (10 label sheets side-by-side, at about 1.5 inches wide each). This slitting eliminates the need of a print margin around individual label sheets 10, which will be cut, stacked, bound and separated into pads in the following steps.

After the slitting station, label stock construction sheet 34 is passed to the die cutting station where die cut 40 is cut into each of the gel ink-writable surfaces 32, comprised of facestock 20 and “doubly hit” ink layer 22, providing label 30, having ink thereon disposed in accordance with the teachings of the present invention, to provide desired label shapes, as described previously. This produces a “master strip”, which, in the present example, is comprised of the approximately 15 inch wide label stock construction sheet 34 having ten adjacent individual label sheets 10 each comprised of background border portion 12 and label 30. Once again note that the dark ink is preferably printed beyond the die cuts that outline label 30, in order to ensure that gel ink-writeable surface 32 of label 30 is completely printed with ink (see FIGS. 1 and 2). Exemplary individual label sheets 10 are approximately 1.5×4.0 inches and the “master strip”, as detailed above, may contain ten of these individual label sheets 10, all printed upon approximately 15 inch wide label stock construction sheet 34.

Additionally at the die cutting station, exemplary cut and tie configurations are provided with 1/32″ ties spaced 1.5 inches apart (same width as the eventual finished label pad's width) are created between the ten exemplary, individual label sheets 10 that make up the label stock construction sheet 34. Various types of guillotines or cutting apparatus may also be utilized, as known to those skilled in the art. This provides a “master strip” for efficient, later padding and further allows the pads to be separated at the pad separation process, detailed below.

The “master strip” is then sheeted at 4-inch intervals due to the exemplary length of the pads in this example. Each resulting sheet is 15 inches wide and 4 inches in length. After sheeting, the “master strip” of labels containing the ten individual label sheets 10 are placed into stacks comprised of thirty “master strips” and are then moved on to the padding/gluing station.

Once at the padding/gluing station, a count of thirty master strips are placed into the padding equipment where the top edges of the stacked “master strips” are roughened and glued. A hot-melt adhesive is utilized having a synthetic resin base, although other glues and adhesives utilized in the bonding and pad manufacturing arts may be utilized. As an example, hot melt adhesives applied to the top edges of the stacked “master strips” may be about 0.001 inches in thickness.

Once the stack of thirty “master strips” are padded, they may be separated into individual pads, ten pads in this example, each pad containing thirty individual label sheets 10. The separation of the gel ink label pads 45 from one another is facilitated by the 1/32″ cut and tie “perforations” executed at the die cutting station, as previously mentioned.

The exemplary gel ink pads 45 contain a plurality of label sheets 10 bound into a pad formation by adhesive 50 applied to at least one edge of the label stacks. The label pads 45 may now be placed into the packaging of choice to give the finished product. For example, a gel ink writing kit may be made up of a gel ink writing instrument 48, such as a pen, and a pad or pads of label sheets 10 having labels 30 with gel ink writable surfaces 32 of similar or differing shapes, as depicted in FIG. 5, where pads having oval and banner shaped labels are shown. Such label constructions are not to be limited to the shapes and outlines shown or described in the specification or figures. Exemplary labels produced in accordance with the teachings of the present invention may be cut and configured having various shapes, such as clouds, banners, various geometric shapes such as circles, rectangles and squares, as well as ovals and thunderbolts, just to name a few. Virtually any desired shape of label may be designed and manufactured in accordance to the teachings of the present invention.

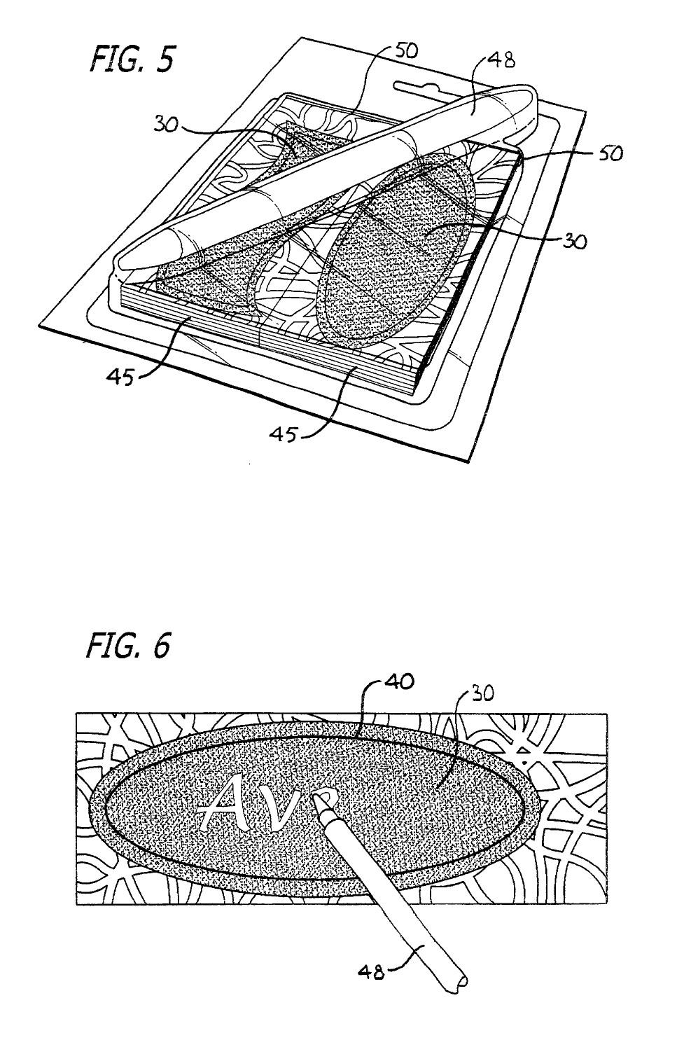

As can be seen the gel ink pen and pad containing gel ink media may be packaged in a blister pack-type of packaging. In FIG. 6, a gel ink pen is seen disposing indicia upon exemplary label 30, according to the teachings of the present invention. Also, the pads 45, comprising a plurality of label sheets 10, may themselves be packaged alone without writing utensil 48, so that users may select a gel ink dispersing utensil of their choice.

It is noted in passing that the labels shown in FIGS. 1, 2, 5,and 6 are preferably coated with black ink or very dark ink, but are shown as darkly stippled areas in view of the U.S. Patent Office requirements that no fully black areas be included in drawings.

The foregoing detailed description and in the accompanying drawings disclose specific illustrative embodiments and methods. It is, however, intended that various modifications or variations could be employed. Therefore, by way of example and not of limitation, instead of pads of gel ink writeable labels, 8.5 inch by 11 inch or A-4 size sheets may be provided with sets of labels mounted thereon, with the label areas being inked with black or very dark colored ink. Similarly, index cards, file folders or dividers, envelopes, index tabs and cards or other paper goods may be provided with ink darkened areas for receiving contrasting gel ink indicia. It is also noted that instead of adhesive at one end of the pad of gel ink labels, the label assemblies may be formed into a pad with releasable adhesive between the label assemblies (sheets).

Accordingly, it is to be understood that the invention is not limited to the specific products or methods described in detail herein.

We claim:

1. A gel ink writable label pad assembly comprising
a plurality of label sheet assemblies in a stack,
each said label assembly including a backing or liner sheet, and a face stock sheet overlying said backing sheet;
said face stock sheet being die cut to form a label, the face stock sheet being formed of light colored paper;
an adhesive layer on said face stock sheet, between said face stock sheet and said backing or liner sheet, with said backing or liner sheet having a thin release layer thereon to permit easy removal of each said label;
the exposed surface of each said label being coated with dark colored ink; with outer areas of said face stock having a lighter colored design;
said outer surface of each said facestock sheet bearing a legend indicating that the label is usable with gel ink pens;
additional adhesive for securing said labels together to form a pad, with said label assemblies being individually removable from said pad; and
gel ink writing on at least one of said labels, with a gel ink which is of contrasting color with respect to said dark colored ink.

2. An assembly as defined in claim 1 wherein each pad assembly is equal to or less than 3 inches by 6 inches in size.

3. A gel ink label sheet assembly comprising:
a backing or liner sheet, and a face stock sheet overlying said backing sheet,
said face stock sheet being die cut to form at least one label, the face stock sheet being formed of light colored paper;
an adhesive layer on said face stock sheet, between said face stock sheet and said backing or liner sheet, with said backing or liner sheet having a thin release layer thereon to permit easy removal of each said label;
the exposed surface of each said label being coated with dark colored ink; with outer areas of said face stock having a lighter colored design;
said outer surface of said facestock sheet bearing a legend indicating that the label is usable with gel ink pens; and
gel ink writing on at least one of said labels, with a gel ink which is of contrasting color with respect to said dark colored ink.

4. An assembly as defined in claim 3 wherein a plurality of said labels are mounted on a single backing sheet.

5. A method relating to gel ink printing comprising the steps of:
providing a light colored substrate;
placing said substrate into a printing press or printer;
applying onto an area of said light colored substrate, as it moves through said printing press or printer, a dark ink so as to define a gel ink writeable/printable surface having a dark coloration;
repeating said application of dark ink onto the same area of said light colored substrate at least once more;
allowing said gel ink writeable/printable surface to dry, thereby providing said gel ink writeable/printable surface for gel ink printing; and
disposing upon said gel ink writeable/printable surface gel ink having a contrasting color.

6. The method relating to gel ink printing of claim 5 wherein said light colored substrate is comprised of paper.

7. The method relating to gel ink printing of claim 5, wherein said light colored substrate is comprised of paper facestock.

8. The method relating to gel ink printing of claim 7, wherein said light colored substrate is further comprised of a liner and an adhesive layer.

9. The method relating to gel ink printing of claim 5, wherein said light colored substrate comprises a label stock construction.

10. The method relating to gel ink printing of claim 9, wherein said label stock construction, having said gel ink writeable/printable surface disposed thereon, is die cut providing a label sheet having a label and a background portion.

11. The method relating to gel ink printing of claim 10, further comprising the steps of;
stacking a plurality of said label sheets; and
applying an adhesive to one edge of said plurality of said label sheets thereby providing a coherent pad of label sheets each label being comprised of said gel ink writeable/printable surface.

12. The method relating to gel ink printing of claim 5, wherein the color of said ink is selected from the group consisting of black, purple, dark blue, dark maroon and burgundy.

13. The method relating to gel ink printing of claim 5, wherein said light colored substrate is comprised of material selected from the group consisting of plastics, vinyl, foam and paper.

14. The method relating to gel ink printing of claim 5 wherein said light colored substrate comprise cards, index tabs, dividers, binders or paper.

15. A method as defined in claim 5, further comprising the step of writing on said surface with a gel ink pen with gel ink having a color contrasting with the color of said surface.

16. A method for producing adhesive labels comprised of media for gel ink printing, said method comprising the steps of:
loading a label stock construction comprised of a facestock, adhesive and liner into a processing line of equipment;
printing a background border portion onto said facestock;
printing a label portion onto said facestock with dark ink, thereby providing a gel ink writable/printable surface on said facestock, resulting in a plurality of label sheets;
forming an adhesive label by die cutting said facestock having said gel ink writable/printable surface;
stacking a plurality of said label sheets on top of one another; and
applying an adhesive along an edge of said stacked label sheets thereby producing a pad of label sheets comprised of labels having a gel ink writable/printable surface.

17. The method for producing adhesive labels comprised of media for gel ink printing according to claim 16, wherein said step of printing a label portion onto said facestock with dark ink is executed at least twice so that said gel ink writable/printable surface on said facestock is coated with dark ink to darken said label portion.

18. Media for gel ink printing comprising:
a light colored substrate;
a gel ink writable/printable surface comprised of a dark and/or colored ink, disposed upon said light colored substrate; and
a liner and an adhesive, said adhesive disposed between said light colored substrate having said dark and/or colored ink thereon disposed, and said liner, thereby providing a label sheet.

19. The media for gel ink printing of claim 18, wherein said label sheet is cut to provide a label comprised of said substrate with said dark and/or colored ink disposed on one side of said substrate, and said adhesive disposed upon the opposite side of said substrate.

20. A method for printing indicia upon a gel ink writeable/printable surface having a dark coloration, comprising the steps of:
providing a media for gel ink printing, said media having said gel ink writeable/printable surface comprised of a light colored substrate having dark and/or colored ink thereon disposed; and
disposing indicia comprised of gel ink onto said media, wherein said media and said gel ink have contrasting colors.

21. The method for printing indicia upon a gel ink writeable/printable surface according to claim 20, wherein said media is comprised of
a light colored substrate; and
a gel ink writable/printable surface, comprised of a dark and/or colored ink, disposed upon said light colored substrate.

22. The method for printing indicia upon a gel ink writeable/printable surface according to claim 21, wherein said disposition of said indicia comprised of gel ink onto said media is facilitated by a gel ink pen.

23. The method for printing indicia upon a gel ink writeable/printable surface according to claim 22, wherein said media is comprised of material selected from the group consisting of paper, plastic and vinyl.
